(19) United States
(12) Patent Application Publication
(10) Pub. No.: US 2022/0372397 A1
(43) Pub. Date: Nov. 24, 2022

(54) DETERGENT COMPOSITION

(71) Applicant: Conopco, Inc., d/b/a UNILEVER, Englewood Cliffs, NJ (US)

(72) Inventors: Stephen Norman BATCHELOR, Chester (GB); Julie BENNETT, Port Sunlight, Wirral (GB); Jonathan BEST, Frodsham (GB); David Christopher THORLEY, Shavington (GB)

(73) Assignee: Conopco, Inc., d/b/a UNILEVER, Englewood Cliffs, NJ (US)

(21) Appl. No.: 17/621,675

(22) PCT Filed: May 28, 2020
(86) PCT No.: PCT/EP2020/064851

§ 371 Date: Dec. 21, 2021

(30) Foreign Application Priority Data
Jun. 28, 2019 (EP) 19183240.1

(51) Int. Cl. C11D 1/29; C11D 3/386; C11D 3/00; C11D 3/20; C11D 3/34; C11D 11/00

(52) U.S. Cl. CPC C11D 1/29; C11D 3/386; C11D 3/0015; C11D 3/2093; C11D 3/3418; C11D 11/0017

(57) ABSTRACT

A detergent composition, comprising: (a) from 2 to 25 wt. % of an alcohol ether sulfate of formula R₁—(OCH₂CH₂)ₘOSO₃H where R₁ is saturated or monounsaturated, preferably saturated, linear C12 and/or C14 alkyl chain and where m is from 1 to 4; and, (b) from 2 to 25 wt. % of an alcohol ether sulfate of formula R₂—(OCH₂CH₂)ₙOSO₃H where R₂ is saturated or monounsaturated linear C16 and/or C18 alkyl chain and where n is from 5 to 20; wherein the weight ratio of (a) to (b) is from 5:1 to 1:8. A domestic method of treating a textile with an aqueous solution of 0.5 to 20 g/L of said detergent composition.

### FIELD OF INVENTION

The present invention concerns a detergent composition. More particularly a detergent composition comprising a C16 and/or C18 ether sulfate surfactant.

### BACKGROUND OF THE INVENTION

Alcohol ether sulfates are widely used in cleaning applications, such as laundry to solubilise fats. Alcohol ether sulfate surfactants are synthesised using an alcohol as a starting material, with C10 to C14, particularly C12 (lauryl) alkyl chains used in laundry detergents, for example sodium lauryl ether sulfate.

A key problem with these types of alcohol ether sulfates is foam control. For lauryl (C12) and myristyl (C14) ether sulfates, foam levels can be extremely high and lead to overfoaming in washing machines and the use of too much water in the rinse water to remove the foam.

A problem is how to reduce the foam levels of compositions including these useful materials.

Surprisingly, this problem can be solved by inclusion of a C16 and/or C18 ether sulfate.

### SUMMARY OF THE INVENTION

The invention relates to a detergent composition comprising:
a) from 2 to 25 wt. %, preferably from 3 to 20 wt. %, most preferably from 4 to 15 wt. % of an alcohol ether sulfate of formula R₁—(OCH₂CH₂)ₘOSO₃H where R₁ is saturated or monounsaturated linear C12 and/or C14 alkyl chain and where m is from 1 to 4, preferably 1.5 to 3.5; and,
b) from 2 to 25 wt. %, preferably from 3 to 20 wt. %, most preferably from 4 to 15 wt. % of an alcohol ether sulfate of formula R₂—(OCH₂CH₂)ₙOSO₃H where R₂ is saturated or monounsaturated linear C16 and C18 alkyl chain and n is from 5 to 20, preferably from 6 to 14, more preferably from 7 to 13, most preferably from 7 to 12;
   wherein the weight ratio of (a) to (b) is from 5:1 to 1:8, preferably from 4:1 to 1:4, more preferably from 2:1 to 1:2, even more preferably from 1.5:1 to 1:1.5.

Preferably the composition comprises from 0.2 to 50 wt. %, preferably from 1 to 40 wt. %, more preferably from 1.5 to 30 wt. %, even more preferably from 2 to 25 wt. %, most preferably from 4 to 15 wt. % of additional surfactant other than surfactants (a) and (b), wherein the surfactants are selected from: anionic, nonionic or amphoteric surfactants and mixtures thereof. More preferably the surfactant comprises anionic and/or nonionic surfactants.

Preferably the nonionic surfactant is saturated and mono-unsaturated aliphatic alcohol ethoxylate, preferably selected from C₁₂ to C₂₀ primary linear alcohol ethoxylates with an average of from 5 to 30 ethoxylates, more preferably C₁₆ to C₁₈ with an average of from 5 to 25 ethoxylates. Preferably the total amount of nonionic surfactants in a composition of the invention ranges from 0.5 to 10 wt. %, more preferably from 1 to 8 wt. %, even more preferably from 1.5 to 6 wt. %, most preferably from 2 to 5 wt. %.

Preferably the additional anionic surfactant other than anionic surfactants (a) and (b) is selected from C12 to C18 alkyl ether carboxylates; citric acid ester of a C16 to C18 monoglyceride (citrem), tartartic acid esters of a C16 to C18 monoglyceride (tatem) and diacetyl tartaric acid ester of a C16 to C18 monoglyceride (datem); and water-soluble alkali metal salts of organic sulfates and sulfonates having alkyl radicals containing from about 8 to about 22 carbon atoms. Most preferably, the additional anionic surfactant comprises C16 to C18 alkyl ether carboxylates; citric acid ester of a C16 to C18 monoglyceride (citrem), tartartic acid esters of a C16 to C18 monoglyceride (tatem) and diacetyl tartaric acid ester of a C16 to C18 monoglyceride (datem) and sulfonates, for example, linear alkyl benzene sulfonate.

Preferably the total amount of additional anionic surfactant other than anionic surfactants (a) and (b) in a composition of the invention ranges from 0.5 to 20 wt. %, more preferably from 1 to 16 wt. %, even more preferably from 1.5 to 14 wt. %, most preferably from 2 to 12 wt. %.

Preferably the composition comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers, soil release polymers, alkoxylated polycarboxylic acid esters and mixtures thereof.

Preferably the antiredeposition polymers are alkoxylated polyamines; and/or the soil release polymer is a polyester soil release polymer.

Preferably the detergent composition is a laundry detergent composition, more preferably a laundry liquid detergent composition.

Preferably the composition comprises one or more enzymes from the group: lipases proteases, alpha-amylases, cellulases, peroxidases/oxidases, pectate lyases, and mannanases, or mixtures thereof, more preferably lipases, proteases, alpha-amylases, cellulases and mixtures thereof, wherein the level of each enzyme in the composition of the invention is from 0.0001 wt. % to 0.1 wt. %.

In a second aspect the invention provides a domestic method of treating a textile, the method comprising the step of: treating a textile with an aqueous solution of 0.5 to 20 g/L of the detergent composition, preferably the laundry liquid detergent composition, of the first aspect.

### DETAILED DESCRIPTION OF THE INVENTION

The indefinite article “a” or “an” and its corresponding definite article “the” as used herein means at least one, or one or more, unless specified otherwise.

All enzyme levels refer to pure protein.

wt. % relates to the amount by weight of the ingredient based on the total weight of the composition. For charged surfactants (for example anionic surfactants and the C16 and/or C18 ether sulfate (b)), wt. % is calculated based on the protonated form of the surfactant.

The integers m and n are mole average values.

The formulation may be in any form for example a liquid, solid, powder, liquid unit dose. Preferably the composition is a liquid composition.

The formulation when dissolved in demineralised water at 20° C. preferably has a pH of 4 to 8, more preferably 6.5 to 7.5, most preferably 7.

Lauryl and Myristyl Ether Sulfate

The composition comprises from 2 to 25 wt. %, preferably from 3 to 20 wt. %, most preferably from 4 to 15 wt. % of an alcohol ether sulfate of formula R₁—(OCH₂CH₂)ₘOSO₃H where R₁ is saturated or monounsaturated, preferably saturated, linear C12 and/or C14 alkyl chain and where m is from 1 to 4, preferably 1.5 to 3.5. Preferably R₁ is saturated.

The saturated material can also be described as a lauryl (C12) and/or myristyl (C14) ether sulfate with mole average of 1 to 4, preferably 1.5 to 3.5 ethoxylate groups.

C16 and/or C18 Ether Sulfate

Alcohol ether sulfates are discussed in Anionic Surfactants: Organic Chemistry edited by H. W Stache (Marcel Dekker 1996).

The composition comprises from 2 to 25 wt. %, preferably from 3 to 20 wt. %, most preferably from 4 to 15 wt. % of a C16 and/or C18 ether sulfate.

C16 and/or C18 ether sulfates are ether sulfates of the form R₂—(OCH₂CH₂)ₙOSO₃H where R₂ is saturated or monounsaturated linear C16 and/or C18 alkyl and where n is from 5 to 20, preferably from 6 to 14, more preferably from 7 to 13, most preferably from 7 to 12.

The monounsaturation is preferably in the 9 position of the chain, and the double bond may be in a cis or trans configuration (oleyl or elaidic). The cis or trans ether sulfate CH₃(CH₂)₇—CH═CH—(CH₂)₈O—(OCH₂CH₂)ₙOSO₃H, is described as C18:1(Δ9) ether sulfate. 18 is the number of carbon atoms in the chain, 1 is the number of double bonds and Δ9 the position of the double bond on the chain. Most preferably R₂ is selected from linear C16 alkyl, linear C18 alkyl, linear C18:1(Δ9) alkyl and mixtures thereof.

Preferred examples are C16 and/or C18 ether sulfates with alkyl chains selected from a mixture of cetyl (linear C16) and stearyl (linear C18); oleyl ether sulfates and elaidic ether sulfates; and mixtures thereof.

Oleyl ether sulfates have a monounsaturated C18 chain with a cis double bond in the 9 position of the chain. Elaidic ether sulfate have a monounsaturated C18 chain with a trans double bond in the 9 position of the chain.

Alcohol ether sulfates may be synthesised by ethoxylation of an alkyl alcohol to form an alcohol ethoxylate followed by sulfonation and neutralisation with a suitable alkali.

The production of the alcohol ethoxylate involves an ethoxylation reaction:

R—OH+q ethylene oxide→R—O—(CH2CH2O)q-H

Such ethoxylation reactions are described in Non-Ionic Surfactant Organic Chemistry (N. M. van Os ed), Surfactant Science Series Volume 72, CRC Press.

Preferably the reactions are base catalysed using NaOH, KOH, or NaOCH3. Even more preferred are catalyst which provide narrower ethoxy distribution than NaOH, KOH, or NaOCH3. Preferably these narrower distribution catalysts involve a Group II base such as Ba dodecanoate; Group II metal alkoxides; Group II hyrodrotalcite as described in WO2007/147866. Lanthanides may also be used. Such narrower distribution alcohol ethoxylates are available from Azo Nobel and Sasol.

Preferably the ethoxy distribution has greater than 70 wt. %, more preferably greater than 80 w.t % of the alcohol ethoxylate R—O—(CH2CH2O)q-H in the range R—O—(CH2CH2O)x-H to R—O—(CH2CH2O)y-H where q is the mole average degree of ethoxylation and x and y are absolute numbers, where x=q−q/2 and y=q+q/2.

For example when q=10, then the greater than 70 wt. % of the alcohol ethoxylate should consist of ethoxylate with 5, 6, 7, 8, 9 10, 11, 12, 13, 14 and 15 Ethoxylate groups.

The alkyl chain in the alcohol ether sulfate is preferably obtained from plants, preferably from a variety of plants. In this case the oil fraction is preferably extracted, the triglyceride hydrolysed to give the carboxylic acid which is reduced to give the alkyl alcohol required for the surfactant synthesis. Preferably the oil is hydrogenated to removed polyunsaturated alkyl chains such as linoleic and linoleneic acid. Preferred plant sources of oils are palm, rapeseed, sunflower, maze, soy, cottonseed, olive oil and trees. The oil from trees is called tall oil. Most preferably the oil source is rapeseed oils. Palm oil may be used but is not preferred.

Hydrogenation of oils is described in A Practical Guide to Vegetable Oil Processing (Gupta M.K. Academic Press 2017)

The alkyl ether sulfate surfactants may be in salt form or acid form, typically in the form of a water-soluble sodium, potassium, ammonium, magnesium or mono-, di- or tri-C2-C3 alkanolammonium salt, with the sodium cation being the usual one chosen.

Preferably the weight fraction of saturated R₂ (C18 alcohol ether sulfate)/(C16 alcohol ether sulfate) is from 2 to 400, more preferably 8 to 200 where, the weight of the alkyl ether sulfate is for the protonated form R₂—(OCH₂CH₂)ₙOSO₃H.

Linear saturated or mono-unsaturated C20 and C22 alcohol ether sulfate may be present, preferably where n (the average number of moles of ethoxylation) is 6 to 14, preferably 7 to 13. Preferably the ratio of sum of (C18 alcohol ether sulfate)/(C20 and C22 alcohol ether sulfate) is greater than 10.

Further Preferred Ingredients

Additional Surfactants

The composition may comprise additional surfactant other than surfactants (a) and (b) such that the fraction [wt % additional surfactant]/[sum wt % of (a) and (b)] is from 0 to 0.5, preferably 0 to 0.2, most preferably 0 to 0.1.

Additional Anionic Surfactant

The composition may comprise additional anionic surfactant other than anionic surfactants (a) and (b). Any additional anionic surfactant may be used. However preferred surfactants are described below. The anionic surfactants that may be added are additional surfactants to those surfactants specified in (a) and (b) of the claims (the lauryl/myristyl ether sulfates of (a) and the C16 and/or C18 ether sulfates of (b)).

Examples of suitable anionic detergent compounds are selected from C12 to C18 alkyl ether carboxylates; citric acid ester of a C16 to C18 monoglyceride (citrem), tartartic acid esters of a C16 to C18 monoglyceride (tatem) and diacetyl tartaric acid ester of a C16 to C18 monoglyceride (datem); and water-soluble alkali metal salts of organic sulfates and sulfonates having alkyl radicals containing from about 8 to about 22 carbon atoms; and mixtures thereof.

Citrem, tatem and datem are described in Hasenhuettl, G. L and Hartel, R. W. (Eds) Food Emulsifiers and Their Application. 2008 (Springer) and in Whitehurst, R. J. (Ed) Emulsifiers in Food Technology 2008 (Wiley-VCH).

Most preferably, the additional anionic surfactant comprises C16 to C18 alkyl ether carboxylates; citric acid ester of a C16 to C18 monoglyceride (citrem), tartartic acid esters of a C16 to C18 monoglyceride (tatem) and diacetyl tartaric acid ester of a C16 to C18 monoglyceride (datem) and sulfonates, for example, linear alkyl benzene sulfonate.

Preferably the total amount of additional anionic surfactant is 0 to 100 wt. % of the additional surfactant, preferably 30 to 90 wt. %

Preferably the total amount of additional anionic surfactant other than anionic surfactants (a) and (b) in a composition of the invention ranges from 0.5 to 20 wt. %, more preferably from 1 to 16 wt. %, even more preferably from 1.5 to 14 wt. %, most preferably from 2 to 12 wt. %.

Preferably the surfactants used are saturated or mono-unsaturated. Preferably the alkyl chains are derived from natural sources.

Nonionic Surfactant

The composition may comprise nonionic surfactant. Any nonionic surfactant may be used, however, preferred nonionic surfactants are described below.

Nonionic surfactants are preferably selected from saturated and mono-unsaturated aliphatic alcohol ethoxylates.

Aliphatic alcohol ethoxylates for use in the invention may suitably be selected from C₈ to C₁₈ primary or secondary linear or branched alcohol ethoxylates with an average of from 2 to 40 moles of ethylene oxide per mole of alcohol.

Preferably the nonionic surfactant is saturated and mono-unsaturated aliphatic alcohol ethoxylate, preferably selected from C₁₂ to C₂₀ primary linear alcohol ethoxylates with an average of from 5 to 30 ethoxylates, more preferably C₁₆ to C₁₈ with an average of from 5 to 25 ethoxylates. Preferably the alkyl chain is mono-unsaturated.

Mixtures of any of the above described materials may also be used.

Preferably the total amount of nonionic surfactants in a composition of the invention ranges is 0 to 100 wt. % of the additional surfactant, preferably 10 to 70 wt. % of the additional surfactant.

Preferably the total amount of nonionic surfactants in a composition of the invention ranges from 0.5 to 10 wt. %, more preferably from 1 to 8 wt. %, even more preferably from 1.5 to 6 wt. %, most preferably from 2 to 5 wt. %.

Cleaning Boosters

The composition preferably comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers; soil release polymers; alkoxylated polycarboxylic acid esters as described in WO/2019/008036 and WO/2019/007636; and mixtures thereof.

Antiredeposition Polymers

Preferred antiredeposition polymers include alkoxylated polyamines.

A preferred alkoxylated polyamine comprises an alkoxylated polyethylenimine, and/or alkoxylated polypropylenimine. The polyamine may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25. A preferred material is ethoxylated polyethyleneimine, with an average degree of ethoxylation being from 10 to 30 preferably from 15 to 25, where a nitrogen atom is ethoxylated.

Soil Release Polymer

Preferably the soil release polymer is a polyester soil release polymer.

Preferred soil release polymers include those described in WO 2014/029479 and WO 2016/005338.

Preferably the polyester based soil release polymer is a polyester according to the following formula (I)

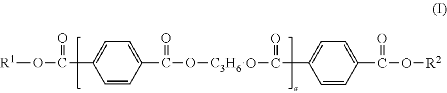

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9.

Preferably the polyester provided as an active blend comprising:
A) from 45 to 55% by weight of the active blend of one or more polyesters according to the following formula (I)

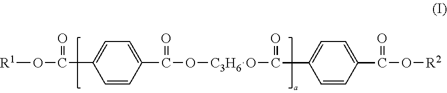

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9 and
B) from 10 to 30% by weight of the active blend of one or more alcohols selected from the group consisting of ethylene glycol, 1,2-propylene glycol, 1,3-propylene glycol, 1,2-butylene glycol, 1,3-butylene glycol, 1,4-butylene glycol and butyl glycol and
C) from 24 to 42% by weight of the active blend of water.

Alkoxylated Polycarboxylic Acid Esters

Alkoxylated polycarboxylic acid esters are obtainable by first reacting an aromatic polycarboxylic acid containing at least three carboxylic acid units or anhydrides derived therefrom, preferably an aromatic polycarboxylic acid containing three or four carboxylic acid units or anhydrides derived therefrom, more preferably an aromatic polycarboxylic acid containing three carboxylic acid units or anhydrides derived therefrom, even more preferably trimellitic acid or trimellitic acid anhydride, most preferably trimellitic acid anhydride, with an alcohol alkoxylate and in a second step reacting the resulting product with an alcohol or a mixture of alcohols, preferably with C16/C18 alcohol.

Enzymes

Preferably enzymes, such as lipases, proteases, alpha-amylases, cellulases, peroxidases/oxidases, pectate lyases, and mannanases, or mixtures thereof, may be present in the formulation.

If enzymes are present, then preferably they are selected from: lipases, proteases, alpha-amylases, cellulases and mixtures thereof.

If present, then the level of each enzyme in the laundry composition of the invention is from 0.0001 wt. % to 0.1 wt. %.

Levels of enzyme present in the composition preferably relate to the level of enzyme as pure protein.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422). Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063.

Preferred commercially available lipase enzymes include Lipolase™ and Lipolase Ultra™, Lipex™ and Lipoclean™ (Novozymes A/S).

The invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

Protease enzymes hydrolyse bonds within peptides and proteins, in the laundry context this leads to enhanced removal of protein or peptide containing stains. Examples of suitable proteases families include aspartic proteases; cysteine proteases; glutamic proteases; aspargine peptide lyase; serine proteases and threonine proteases. Such protease families are described in the MEROPS peptidase database (http://merops.sanger.ac.uk/). Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN', subtilisin 309, subtilisin 147 and subtilisin 168 described in WO 89/06279 and protease PD138 described in (WO 93/18140). Other useful proteases may be those described in WO 92/175177, WO 01/016285, WO 02/026024 and WO 02/016547. Examples of trypsin-like proteases are trypsin (e.g. of porcine or bovine origin) and the Fusarium protease described in WO 89/06270, WO 94/25583 and WO 05/040372, and the chymotrypsin proteases derived from Cellumonas described in WO 05/052161 and WO 05/052146.

Most preferably the protease is a subtilisins (EC 3.4.21.62).

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN', subtilisin 309, subtilisin 147 and subtilisin 168 described in WO89/06279 and protease PD138 described in (WO93/18140). Preferably the subsilisin is derived from Bacillus, preferably Bacillus lentus, B. alkalophilus, B. subtilis, B. amyloliquefaciens, Bacillus pumilus and Bacillus gibsonii as described in U.S. Pat. No. 6,312,936 BI, U.S. Pat. Nos. 5,679,630, 4,760,025, 7,262,042 and WO 09/021867. Most preferably the subtilisin is derived from Bacillus gibsonii or Bacillus Lentus.

Suitable commercially available protease enzymes include those sold under the trade names names Alcalase®, Blaze@; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra@ or Evity® (Novozymes A/S).

The invention may use cutinase, classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora 20 thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Celluclean™, Endolase™ Renozyme™ (Novozymes A/S), Clazinase™ and Puradax HA™ (Genencor International Inc.), and KAC-500(B)™ (Kao Corporation). Celluclean™ is preferred.

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are discussed in WO 2009/087524, WO 2009/090576, WO 2009/107091, WO 2009/111258 and WO 2009/148983.

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Further Ingredients

The formulation may contain further ingredients.

Builders or Complexing Agents

The composition may comprise a builder or a complexing agent.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

The composition may also contain 0-10 wt. % of a builder or complexing agent such as ethylenediaminetetraacetic acid, diethylenetriamine-pentaacetic acid, citric acid, alkyl- or alkenylsuccinic acid, nitrilotriacetic acid or the other builders mentioned below.

More preferably the laundry detergent formulation is a non-phosphate built laundry detergent formulation, i.e., contains less than 1 wt. % of phosphate. Most preferably the laundry detergent formulation is not built i.e. contain less than 1 wt. % of builder.

If the detergent composition is an aqueous liquid laundry detergent it is preferred that mono propylene glycol or glycerol is present at a level from 1 to 30 wt. %, most preferably 2 to 18 wt. %, to provide the formulation with appropriate, pourable viscosity.

Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090-02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphostyryl)biphenyl.

Shading Dye

It is advantageous to have shading dye present in the formulation.

Dyes are described in Color Chemistry Synthesis, Properties and Applications of Organic Dyes and Pigments, (H Zollinger, Wiley VCH, Zurich, 2003) and, Industrial Dyes Chemistry, Properties Applications. (K Hunger (ed), Wiley-VCH Weinheim 2003).

Dyes for use in laundry detergents preferably have an extinction coefficient at the maximum absorption in the visible range (400 to 700 nm) of greater than 5000 L mol⁻¹ cm⁻¹, preferably greater than 10000 L mol⁻¹ cm⁻¹.

Preferred dye chromophores are azo, azine, anthraquinone, phthalocyanine and triphenylmethane. Azo, anthraquinone, phthalocyanine and triphenylmethane dyes preferably carry a net anionic charged or are uncharged. Azine dyes preferably carry a net anionic or cationic charge.

Blue or violet Shading dyes are most preferred. Shading dyes deposit to fabric during the wash or rinse step of the washing process providing a visible hue to the fabric. In this regard the dye gives a blue or violet colour to a white cloth with a hue angle of 240 to 345, more preferably 260 to 320, most preferably 270 to 300. The white cloth used in this test is bleached non-mercerised woven cotton sheeting.

Shading dyes are discussed in WO2005/003274, WO2006/032327(Unilever), WO2006/032397(Unilever), WO2006/045275(Unilever), WO 2006/027086(Unilever), WO2008/017570(Unilever), WO 2008/141880(Unilever), WO2009/132870(Unilever), WO 2009/141173 (Unilever), WO 2010/099997(Unilever), WO 2010/102861(Unilever), WO 2010/148624(Unilever), WO2008/087497 (P&G), WO2011/011799 (P&G), WO2012/054820 (P&G), WO2013/142495 (P&G) and WO2013/151970 (P&G).

A mixture of shading dyes may be used.

The shading dye chromophore is most preferably selected from mono-azo, bis-azo and azine.

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO2013/142495 and WO2008/087497. A preferred example of a thiophene dye is shown below:

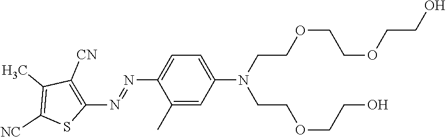 [SMILES: Cc1cc(N(CCOCCO)CCOCCOCCO)ccc1/N=N/c1sc(C#N)c(C)c1C#N]

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, direct violet 66, direct violet 99 and alkoxylated versions thereof.

Alkoxylated bis-azo dyes are discussed in WO2012/054058 and WO/2010/151906. An example of an alkoxylated bis-azo dye is:

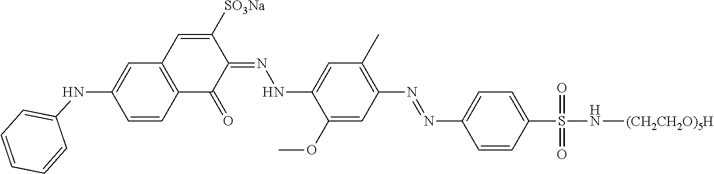

Azine dyes are preferably selected from sulphonated phenazine dyes and cationic phenazine dyes. Preferred examples are acid blue 98, acid violet 50, dye with CAS-No 72749-80-5, acid blue 59, and the phenazine dye selected from:

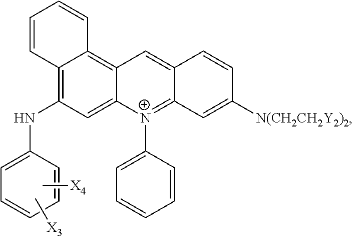

wherein:
X₃ is selected from: —H; —F; —CH₃; —C₂H₅; —OCH₃; and, —OC₂H₅;
X₄ is selected from: —H; —CH₃; —C₂H₅; —OCH₃; and, —OC₂H₅;
Y₂ is selected from: —OH; —OCH₂CH₂OH; —CH(OH)CH₂OH; —OC(O)CH₃; and, C(O)OCH₃.

Anthraquinone dyes covalently bound to ethoxylate or propoxylated polyethylene imine may be used as described in WO2011/047987 and WO 2012/119859.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class. As stated above the shading dye is preferably a blue or violet shading dye.

Perfume

The composition preferably comprises a perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorg.org/en-us/ingredients#.U7Z4hPldWzk) The Research Institute for Fragrance Materials provides a database of perfumes (fragrances) with safety information.

Perfume top note may be used to cue the whiteness and brightness benefit of the invention. Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low C Log P (ie. those which will have a greater tendency to be partitioned into water), preferably with a C Log P of less than 3.0. These materials, of relatively low boiling point and relatively low C Log P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricyclco decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian.

It is preferred that the laundry treatment composition does not contain a peroxygen bleach, e.g., sodium percarbonate, sodium perborate, and peracid.

Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Where alkyl groups are sufficiently long to form branched or cyclic chains, the alkyl groups encompass branched, cyclic and linear alkyl chains. The alkyl groups are preferably linear or branched, most preferably linear.

Adjunct Ingredients

The detergent compositions optionally include one or more laundry adjunct ingredients.

To prevent oxidation of the formulation an anti-oxidant may be present in the formulation.

The term “adjunct ingredient” includes: perfumes, dispersing agents, stabilizers, pH control agents, metal ion control agents, colorants, brighteners, dyes, odour control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mould control agents, mildew control agents, antiviral agents, antimicrobials, drying agents, stain resistance agents, soil release agents, malodour control agents, fabric refreshing agents, chlorine bleach odour control agents, dye fixatives, dye transfer inhibitors, shading dyes, colour maintenance agents, colour restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition.

The invention will be further described with the following non-limiting examples.

### EXAMPLES

A laundry detergent containing 10 wt. % of surfactant (remainder water) was added to 6° fH (degrees French Hardness) water at 293K to give 0.2 g/L surfactant in water.

10 ml of the solution was placed in a tube of 2.2 cm diameter and stoppered. The tube was inverted 40 times to produce foam and a photograph taken of the tube. Soil was then added in 1 mg aliquots and the inversion process and photography cycle repeated until 4 mg total soil was added. The soil was an emulsion with a weight ratio of 5:5:1 olive oil:water:kaolin+0.13 wt. % flour. Kaolin was purchased from Sigma-Aldrich.

The height of the foam was measured as the difference between the meniscus and top of the foam. The experimental values are the average of 2 repeat tubes.

A plot of soil level versus foam height was made for 1 to 4 mg soil and a straight line fitted to the points using regression analysis (LINEST function of Microsoft excel).

The gradient is the change of foam level per unit soil (Δfoam), and the intercept is a measure of the maximum foam (Foam^{Max}). The values are given in the table below, alongside the standard error (±values). The expected values were calculated from the values at 100% with a linear relationship based on the inclusion levels.

| lauryl | cetearyl | Foam^{Max} | Foam^{Max} | Δfoam | Δfoam |
|---|---|---|---|---|---|
| % | % | experiment | expected | experiment | expected |
| 100 | 0 | 84.7 (±2.1) | — | 1.8 (±0.8) | |
| 80* | 20 | 63.7 (±2.2) | 69.2 | −2.9 (±0.8) | 1.3 |
| 50* | 50 | 24.7 (±1.3) | 46.0 | −2.7 (±0.5) | 0.5 |
| 20* | 80 | 12.3 (±0.7) | 22.8 | −1.4 (±0.3) | −0.2 |
| 0 | 100 | 7.4 (±0.3) | — | −0.7 (±0.1) | |

Cetearyl is a mixture of C16 and C18 linear saturated chains.

Lauryl is C12 linear saturated chains.

Values marker with an * are inventive, other values are comparative.

The error limits on the Foam^{Max} expected were calculated from the errors on the Foam^{Max} experiment for the 100% surfactants.

The observed differences between experiment and expected are bigger than error.

Surprisingly the mixture of lauryl and C16 and/or C18 ether sulfate at the weight ratios claimed gives less foam (Foam^{Max} experiment) than expected (Foam^{Max} expected) and a greater reduction with soil (Δfoam) than expected (the experimental values are less than the calculated expected value).

### Example 2

A laundry detergent containing 10 wt. % of surfactant (remainder water) was added to 6° fH (degrees French Hardness) water at 293K to give 0.15 g/L surfactant in water.

10 ml of the solution was placed in a tube of 2.2 cm diameter and stoppered. The tube was inverted 40 times to produce foam and a photograph taken of the tube. Soil was then added in 1 mg aliquots and the inversion process and photography cycle repeated until 4 mg total soil was added. The soil was an emulsion with a weight ratio of 5:5:1 olive oil:water:kaolin+0.13 wt. % flour. Kaolin was purchased from Sigma-Aldrich. A different batch of soil ingredients was used to example 1.

The height of the foam was measured as the difference between the meniscus and top of the foam. The experimental values are the average of 3 repeat tubes.

A plot of soil level versus foam height was made for 1 to 4 mg soil and a straight line fitted to the points using regression analysis (LINEST function of Microsoft excel).

The gradient is the change of foam level per unit soil (Δfoam), and the intercept is a measure of the maximum foam (Foam^{Max}). The values are given in the table below, alongside the standard error (±values). The expected values were calculated from the values at 100% with a linear relationship based on the inclusion levels.

| lauryl | Oleyl | Foam^{Max} | Foam^{Max} | Δfoam | Δfoam |
|---|---|---|---|---|---|
| % | % | experiment | expected | experiment | expected |
| 100 | 0 | 72.1 (±2.9) | — | −0.5 (±1.1) | |
| 88 | 12 | 61.5 (±2.0) | 64.2 (±2.6) | −3.2 (±0.7) | −0.8 |
| 60* | 40 | 34.6 (±2.5) | 45.7 (±2.0) | −4.8 (±0.9) | −1.0 |
| 40* | 60 | 21.2 (±1.4) | 32.5 (±1.5) | −2.8 (±0.5) | −0.6 |
| 12* | 88 | 16.0 (±0.9) | 14.0 (±0.9) | −2.1 (±0.3) | −0.5 |
| 0 | 100 | 6.1 (±0.6) | — | −0.2 (±0.2) | |

Oleyl is a monounsaturated C18 chain with an average of 6 moles of ethoxylation.

Lauryl is C12 linear saturated chains with an average of 3 moles of ethoxylation.

Values marker with an * are inventive, other values are comparative.

The error limits on the Foam^{Max} expected were calculated from the errors on the Foam^{Max} experiment for the 100% surfactants.

The 88:12 lauryl:oleyl (7.3:1 ratio) comparative fairly reflects the teaching of the prior art, which was 8.5 wt. % lauryl to 0.7 wt. % oleyl (this gives a ˜12:1 ratio) as it is closer to the end of the claimed range of 5:1 to 1:8.

The Foam^{Max} experimental values for mixtures of surfactants are significantly lower than expected values, except for the 88:12 lauryl:oleyl, where the values are within error. The % improvement for the technical effect of improved foam is better for the claimed mixture of materials compared to the prior art mixture.

Surprisingly the mixture of lauryl and C16 and/or C18 ether sulfate at the weight ratios claimed gives significantly less foam (Foam^{Max} experiment) than expected (Foam^{Max} expected) and a greater reduction with soil (Δfoam) than expected (the experimental values are less than the calculated expected value).

1. A detergent composition, comprising:
a) from 2 to 25 wt. %, preferably from 3 to 20 wt. %, most preferably from 4 to 15 wt. % of an alcohol ether sulfate of formula R₁—(OCH₂CH₂)ₘOSO₃H where R₁ is saturated or monounsaturated, preferably saturated, linear C12 and/or C14 alkyl chain and where m is from 1 to 4, preferably 1.5 to 3.5; and,
b) from 2 to 25 wt. %, preferably from 3 to 20 wt. %, most preferably from 4 to 15 wt. % of an alcohol ether sulfate of formula R₂—(OCH₂CH₂)ₙOSO₃H where R₂ is saturated or monounsaturated linear C16 and C18 alkyl chain and n is from 5 to 20, preferably from 6 to 14, more preferably from 7 to 13, most preferably from 7 to 12;
wherein the weight ratio of (a) to (b) is from 5:1 to 1:8, preferably from 4:1 to 1:4, more preferably from 2:1 to 1:2, even more preferably from 1.5:1 to 1:1.5.

2. A detergent composition according to claim 1, wherein the composition comprises from 0.2 to 50 wt. %, preferably from 1 to 40 wt. %, more preferably from 1.5 to 30 wt. %, even more preferably from 2 to 25 wt. %, most preferably from 4 to 15 wt. % of additional surfactant other than surfactants (a) and (b), wherein the surfactants are selected from: anionic, nonionic or amphoteric surfactants and mixtures thereof.

3. A detergent composition according to claim 2, wherein the additional surfactant comprises anionic and/or nonionic surfactants.

4. A detergent composition according to claim 2, comprising from 0.5 to 10 wt. %, preferably from 1 to 8 wt. %, more preferably from 1.5 to 6 wt. %, most preferably from 2 to 5 wt. % of nonionic surfactant, wherein the nonionic surfactant is saturated and mono-unsaturated aliphatic alcohol ethoxylate, preferably selected from C₁₂ to C₂₀ primary linear alcohol ethoxylates with an average of from 5 to 30 ethoxylates, more preferably C₁₆ to C₁₈ with an average of from 5 to 25 ethoxylates.

5. A detergent composition according to claim 2, comprising from 0.5 to 20 wt. %, more preferably from 1 to 16 wt. %, even more preferably from 1.5 to 14 wt. %, most preferably from 2 to 12 wt. % of additional anionic surfactant other than anionic surfactants (a) and (b), wherein the anionic surfactant is selected from C12 to C18 alkyl ether carboxylates; citric acid ester of a C16 to C18 monoglyceride (citrem), tartartic acid esters of a C16 to C18 monoglyceride (tatem) and diacetyl tartaric acid ester of a C16 to C18 monoglyceride (datem); and water-soluble alkali metal salts of organic sulfates and sulfonates having alkyl radicals containing from about 8 to about 22 carbon atoms; and mixtures thereof; most preferably, the anionic surfactant is selected from C16 to C18 alkyl ether carboxylates; citric acid ester of a C16 to C18 monoglyceride (citrem), tartartic acid esters of a C16 to C18 monoglyceride (tatem) and diacetyl tartaric acid ester of a C16 to C18 monoglyceride (datem) and sulfonates, for example, linear alkyl benzene sulfonate; and mixtures thereof.

6. A detergent composition according to claim 1, wherein the composition comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers; soil release polymers; alkoxylated polycarboxylic acid esters, and mixtures thereof.

7. A detergent composition according to claim 6, wherein the antiredeposition polymers are alkoxylated polyamines; and/or the soil release polymer is a polyester soil release polymer.

8. A detergent composition according to claim 6, wherein the soil release polymer is a polyester soil release polymer.

9. A detergent composition according to claim 1, wherein the composition is a laundry detergent composition, preferably a laundry liquid detergent composition.

10. A detergent composition according to claim 1, wherein the composition comprises one or more enzymes from the group: lipases, proteases, alpha-amylases, cellulases, peroxidases/oxidases, pectate lyases, and mannanases, or mixtures thereof, preferably lipases, proteases, alpha-amylases, cellulases and mixtures thereof, wherein the level of each enzyme in the composition of the invention is from 0.0001 wt. % to 0.1 wt. %.

11. A domestic method of treating a textile, the method comprising the step of: treating a textile with an aqueous solution of 0.5 to 20 g/L of the detergent composition of claim 1, and optionally drying the textile.
